(19) United States
(12) Patent Application Publication
(10) Pub. No.: US 2016/0068682 A1
(43) Pub. Date: Mar. 10, 2016

(54) BOARD COMPRISING BIODEGRADABLE RESIN AND WOODEN FLOUR AND METHOD OF MANUFACTURING THE SAME

(71) Applicant: LG HAUSYS, LTD., Youngdungpo-gu, Seoul (KR)

(72) Inventors: Seok Bong LEE, Suwon-si (KR); Chang Won KANG, Cheongju-si (KR); Cheng Zhe HUANG, Cheongju-si (KR); Min LEE, Ansan-si (KR)

(73) Assignee: LG HAUSYS, LTD., Seoul (KR)

(21) Appl. No.: 14/787,698

(22) PCT Filed: Jun. 20, 2014
(86) PCT No.: PCT/KR2014/005462

§ 371 Date: Oct. 28, 2015

(30) Foreign Application Priority Data
Jun. 21, 2013 (KR) 10-2013-0071381

(51) Int. Cl. C08L 97/02

(52) U.S. Cl. CPC C08L 97/02

(57) ABSTRACT

Disclosed herein is a board for building or industry comprising biodegradable resin and wooden flour, which is capable of implementing an excellent physical property and protecting the human body and the environment, and a method of manufacturing the same. A method of manufacturing a board may comprise fabricating wooden flour by pulverizing a raw log or wood chips that are raw materials, inputting biodegradable resin to the wooden flour and fabricating compounds by mulling the biodegradable resin and the wooden flour at high temperature, forming the fabricated compounds in a sheet form through mold forming, and cooling the formed board. Accordingly, there are advantages in that an excellent physical property can be implemented, the human body and the environment can be protected because there is no possibility of environmental pollution when the board is buried due to the biodegradable resin, and a cost related to the disposal of wastes can be reduced.

### TECHNICAL FIELD

The present invention relates to a board and, more particularly, to a board for building or industry comprising biodegradable resin and wooden flour, which is capable of implementing an excellent physical property and protecting the human body and the environment, and a method of manufacturing the same.

### BACKGROUND ART

In general, plywood, HDF, and MDF are a lot used for building or floors due to a low price and relatively excellent durability, lightness, and finishability.

However, the plywood, HDF, or MDF is fabricated using a large amount of chemical solvents. In particular, a large amount of chemical substances included in the solvents generates strong smell when the chemical substances are volatilized in a manufacturing process. Accordingly, the chemical substances are harmful to the human body, and become the main cause of environmental pollution.

Furthermore, due to the nature of the materials, the plywood, HDF, or MDF is problematic in that it is difficult to implement high strength because strength is determined by a binder.

Furthermore, a board made of such materials is problematic in that durability is suddenly reduced after some period, there is a difficulty in wasting and disusing the board due to a change of decoration, and a cost for wasting and disusing the board is high.

### DISCLOSURE

### Technical Problem

Accordingly, the present invention has been made in view of the above problems, and it is an object of the present invention to provide a board comprising biodegradable resin and wooden flour, which is capable of implementing an excellent physical property and protecting the human body and the environment because there is no possibility of environmental pollution when the board is buried due to the biodegradable resin, and a method of manufacturing the same.

### Technical Solution

In accordance with an aspect of the present invention, a method of manufacturing a board comprises fabricating wooden flour by pulverizing a raw log or wood chips that are raw materials, inputting biodegradable resin to the wooden flour and fabricating compounds by mulling the biodegradable resin and the wooden flour at high temperature, forming the fabricated compounds in a sheet form through mold forming, and cooling the formed board.

In accordance with another aspect of the present invention, a method of manufacturing a board comprises fabricating wooden flour by pulverizing a raw log or wood chips that are raw materials, inputting biodegradable resin to the wooden flour and fabricating compounds by mulling the biodegradable resin and the wooden flour at high temperature, forming the manufactured compounds in a sheet form through calendering, and cooling the formed board.

In such a case, the biodegradable resin comprises any one of or both poly lactic acid (PLA) and poly hydroxy alkanoates (PHA).

Furthermore, the compounds comprise the wooden flour of 0.1˜80 parts by weight, the biodegradable resin of 5˜90 parts by weight, and calcium carbonate of 0˜95 parts by weight.

Furthermore, the compounds further comprises any one of additives, comprising a compatibilizer of 0.1˜50 parts by weight, a filler of 0.1˜50 parts by weight, an anti-oxidant of 0.1˜30 parts by weight, a lubricant of 0.1˜30 parts by weight, and pigments of 0.1˜30 parts by weight, or further comprises the additives selectively.

Furthermore, cooling the formed board is performed at room temperature.

In accordance with an aspect of the present invention, a board is fabricated by inputting biodegradable resin to wooden flour fabricated by pulverizing a raw log or wood chips, fabricating compounds by mulling the biodegradable resin and the wooden flour at high temperature, forming the fabricated compounds in a sheet form through mold forming or calendering, cooling a product having a sheet form at normal temperature, and cutting the cooled product.

In such a case, the biodegradable resin comprises any one of or both poly lactic acid (PLA) and poly hydroxy alkanoates (PHA).

Furthermore, the compounds comprise the wooden flour of 0.1˜80 parts by weight, the biodegradable resin of 5˜90 parts by weight, and calcium carbonate of 0˜95 parts by weight.

Furthermore, the compounds further comprises any one of additives, comprising a compatibilizer of 0.1˜50 parts by weight, a filler of 0.1˜50 parts by weight, an anti-oxidant of 0.1˜30 parts by weight, a lubricant of 0.1˜30 parts by weight, and pigments of 0.1˜30 parts by weight, or further comprises the additives selectively.

### Advantageous Effects

In accordance with according to the present invention, a board for building or industry is fabricated to comprise biodegradable resin and wooden flour. Accordingly, there are advantages in that an excellent physical property can be implemented, the human body and the environment can be protected because there is no possibility of environmental pollution when the board is buried due to the biodegradable resin, and a cost related to the disposal of wastes can be reduced.

Furthermore, there are advantages in that a worker can be protected because a solvent is not included in a binder and a production cost can be reduced because reused wooden flour, such as sawdust, is used.

### DESCRIPTION OF DRAWINGS

FIG. 1 is a flowchart illustrating a method of manufacturing a board comprising biodegradable resin and wooden flour according to an embodiment of the present invention; and

FIG. 2 is a flowchart illustrating a method of manufacturing a board comprising biodegradable resin and wooden flour according to an embodiment of the present invention.

### MODE FOR INVENTION

Hereinafter, the construction and operation of the present invention according to embodiments are described in detail with reference to the accompanying drawings.

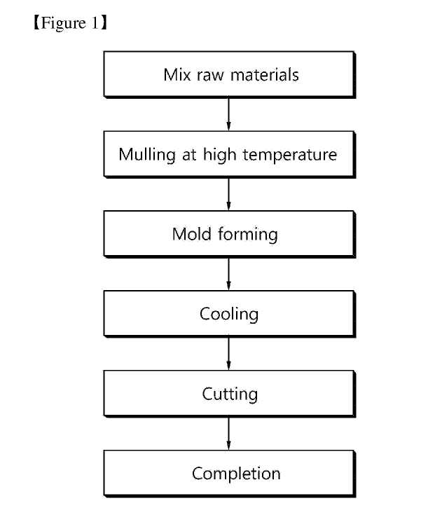

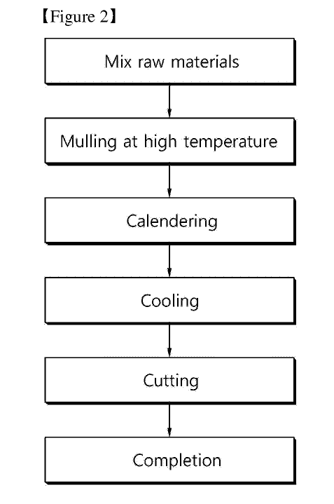

FIG. 1 is a flowchart illustrating a method of manufacturing a board comprising biodegradable resin and wooden flour according to an embodiment of the present invention, and FIG. 2 is a flowchart illustrating a method of manufacturing a board comprising biodegradable resin and wooden flour according to an embodiment of the present invention.

Referring to FIG. 1, a method of manufacturing a board comprising biodegradable resin and wooden flour according to an embodiment of the present invention may comprise fabricating wooden flour by pulverizing a raw log or wood chips, that is, raw materials, inputting biodegradable resin to the wooden flour, fabricating compounds by mulling the biodegradable resin and the wooden flour at high temperature, forming the fabricated compounds in a sheet form, and cooling the formed board.

The board comprising biodegradable resin and wooden flour according to an embodiment of the present invention is described in detail below.

First, the wooden flour may be pulverized in a size of 50˜120 mesh. That is, if the size of the wooden flour is 50 mesh or lower, the dimension stability and modulus of elasticity of the board itself are reduced because the size of the wooden flour itself is increased. In contrast, if the size of the wooden flour is 120 mesh or more, a phenomenon, such as the agglomeration of wooden flour, is generated in a mixing process because the wooden flour is pulverized very minutely, and it is difficult to mix the wooden flour with the biodegradable resin.

The wooden flour fabricated as described above are mixed with the biodegradable resin and other additives, thus forming the compounds. In this case, the compounds may comprise the wooden flour of 0.1˜80 parts by weight, the biodegradable resin of 5˜90 parts by weight, and calcium carbonate of 0˜95 parts by weight.

In this case, the compounds may further comprise any one of a plurality of additives, including a compatibilizer of 0.1˜50 parts by weight, a filler of 0.1˜50 parts by weight, an anti-oxidant of 0.1˜30 parts by weight, a lubricant of 0.1˜30 parts by weight, and pigments of 0.1˜30 parts by weight, or may further comprise the plurality of additives selectively.

In this case, the biodegradable resin may comprise any one of or all of poly lactic acid (PLA) and poly hydroxy alkanoates (PHA), and may further comprise biodegradable resin that is naturally derived.

For reference, the PLA resin is thermoplastic polyester of lactide or lactic acid. The PLA resin may be fabricated by polymerizing lactic acid that is fabricated by fermenting starch extracted from corn or potatoes.

Such a PLA is advantageous in that it can be recycled, it can solve problems attributable to the exhaustion of petroleum resources, it has a very low amount of environmentally toxic substances than other resin, for example, vinyl chloride in a process of disusing the PLA, and it has a fast dissolving speed. Furthermore, the PHA, together with the PLA, is resin that has been spotlighted as the next-generation bio-based polymer.

The compounds fabricated in such a composition ratio are fabricated in a sheet form through a specific forming process. In this case, a process of forming the compounds in a sheet form may be performed using a mold forming method.

Alternatively, as illustrated in FIG. 2, the compounds may be fabricated in a sheet form through calendaring. The calendaring is one of plastic forming processing methods, and is a processing method of producing a forming product by inputting thermoplastic resin between two heated rolls and rolling the thermoplastic resin.

The boards that have experienced the process of forming the compounds in a sheet form through one of such processing methods are slowly cooled at room temperature and are completed as the final products through a specific cutting process.

### EMBODIMENT

PLA resin of 30 wt %, wooden flour of 68 wt %, and a processing aid of 2 wt % were mulled using a Banbury mixer at high temperature. The compounds were formed in a sheet form in a thickness of 10 mm through two heated calendering rolls.

Thereafter, the formed products were cooled at room temperature, and the final boards were fabricated through a specific cutting process.

As described above, the board comprising biodegradable resin and wooden flour according to an embodiment of the present invention is fabricated to comprise the biodegradable resin and the wooden flour. Accordingly, there are advantages in that an excellent physical property can be implemented, the human body and the environment can be protected because there is no possibility of environmental pollution when the board is buried due to the biodegradable resin, and a cost related to the disposal of wastes can be reduced.

Furthermore, there are advantages in that a worker can be protected because a solvent is not included in a binder when the board is fabricated and a production cost can be reduced because reused wooden flour, such as sawdust, is used as a main material of the board.

Furthermore, the board comprising biodegradable resin and wooden flour can supplement a disadvantage of biodegradable resin having a high production cost.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of manufacturing a board, comprising:
fabricating wooden flour by pulverizing a raw log or wood chips that are raw materials;
inputting biodegradable resin to the wooden flour and fabricating compounds by mulling the biodegradable resin and the wooden flour at high temperature;
forming the fabricated compounds in a sheet form through mold forming; and
cooling the formed board.

2. A method of manufacturing a board, comprising:
fabricating wooden flour by pulverizing a raw log or wood chips that are raw materials;
inputting biodegradable resin to the wooden flour and fabricating compounds by mulling the biodegradable resin and the wooden flour at high temperature;
forming the manufactured compounds in a sheet form through calendering; and cooling the formed board.

3. The method of claim 1, wherein the biodegradable resin comprises any one of or both poly lactic acid (PLA) and poly hydroxy alkanoates (PHA).

4. The method of claim 3, wherein the compounds comprise the wooden flour of 0.1˜80 parts by weight, the biodegradable resin of 5˜90 parts by weight, and calcium carbonate of 0˜95 parts by weight.

5. The method of claim 4, wherein the compounds further comprises any one of additives, comprising a compatibilizer of 0.1˜50 parts by weight, a filler of 0.1˜50 parts by weight, an anti-oxidant of 0.1˜30 parts by weight, a lubricant of 0.1˜30 parts by weight, and pigments of 0.1˜30 parts by weight, or further comprises the additives selectively.

6. The method of claim 1, wherein cooling the formed board is performed at room temperature.

7. A board fabricated by inputting biodegradable resin to wooden flour fabricated by pulverizing a raw log or wood chips, fabricating compounds by mulling the biodegradable resin and the wooden flour at high temperature, forming the fabricated compounds in a sheet form through mold forming or calendering, cooling a product having a sheet form at normal temperature, and cutting the cooled product.

8. The board of claim 7, wherein the biodegradable resin comprises any one of or both poly lactic acid (PLA) and poly hydroxy alkanoates (PHA).

9. The board of claim 7, wherein the compounds comprise the wooden flour of 0.1˜80 parts by weight, the biodegradable resin of 5˜90 parts by weight, and calcium carbonate of 0˜95 parts by weight.

10. The board of claim 9, wherein the compounds further comprises any one of additives, comprising a compatibilizer of 0.1˜50 parts by weight, a filler of 0.1˜50 parts by weight, an anti-oxidant of 0.1˜30 parts by weight, a lubricant of 0.1˜30 parts by weight, and pigments of 0.1˜30 parts by weight, or further comprises the additives selectively.

11. The method of claim 2, wherein the biodegradable resin comprises any one of or both poly lactic acid (PLA) and poly hydroxy alkanoates (PHA).

12. The method of claim 11, wherein the compounds comprise the wooden flour of 0.1˜80 parts by weight, the biodegradable resin of 5˜90 parts by weight, and calcium carbonate of 0˜95 parts by weight.

13. The method of claim 12, wherein the compounds further comprises any one of additives, comprising a compatibilizer of 0.1˜50 parts by weight, a filler of 0.1˜50 parts by weight, an anti-oxidant of 0.1˜30 parts by weight, a lubricant of 0.1˜30 parts by weight, and pigments of 0.1˜30 parts by weight, or further comprises the additives selectively.

14. The method of claim 2, wherein cooling the formed board is performed at room temperature.
